(19) United States
(12) Patent Application Publication
(10) Pub. No.: US 2018/0085861 A1
(43) Pub. Date: Mar. 29, 2018

(54) WIRE FOR MELTING TREATMENT AND METHOD OF PRODUCING THE SAME

(71) Applicant: HITACHI METALS, LTD., Tokyo (JP)

(72) Inventors: Gang HAN, Yasugi-shi (JP); Hiroshi TAKASHIMA, Tokyo (JP)

(73) Assignee: HITACHI METALS, LTD., Tokyo (JP)

(21) Appl. No.: 15/715,876

(22) Filed: Sep. 26, 2017

(30) Foreign Application Priority Data
Sep. 28, 2016 (JP) 2016-189868

(51) Int. Cl. B23K 35/30; C22C 19/03; B23K 35/40

(52) U.S. Cl. CPC B23K 35/3033; B23K 35/40; C22C 19/03

(57) ABSTRACT

A wire for a melting treatment is provided and has, as a whole, a component composition of a precipitation-strengthening Ni-based super heat-resistant alloy in which an equilibrium precipitation amount of gamma prime at 700° C. is equal to or greater than 40% by mole. The wire has an integrated structure including: an element wire having a component composition in which the equilibrium precipitation amount of gamma prime at 700° C. is equal to or greater than 0% by mole and less than 40% by mole; and a material having a component composition in which the equilibrium precipitation amount of gamma prime at 700° C. is equal to or greater than 0% by mole and less than 40% by mole, and which is different from the component composition of the element wire. A method of producing the wire for a melting treatment is also provided.

### CROSS-REFERENCE TO RELATED APPLICATIONS

This application is based on and claims priority under 35 USC 119 from Japanese Patent Application No. 2016-189868 filed on Sep. 28, 2016, the entire contents of which are hereby incorporated by reference.

### BACKGROUND OF THE INVENTION

### Technical Field

The present invention relates to a wire for a melting treatment which can be used as a melting material in various melting treatments accompanied by melting of materials, such as welding or 3D printing, and a method of producing the same.

### Background Art

In the related art, as a component part of an aircraft engine and a power generation gas, turbine, “Ni-based super heat-resistant alloy” which is excellent in heat resistance has been widely used. The Ni-based super heat-resistant alloy is classified in terms of strengthening mechanism into a “matrix strengthening type (for example, NCF600 and NCF601 of JIS-G-4901)” and a “precipitation strengthening type (for example, NCF718 of JIS-G-4901, and 713C)” which is strengthened by precipitation of intermetallic compounds such as Al, Ti, and Nb.

In order to improve energy efficiency of the aircraft engine, the power generation gas turbine, or the like, it is required to increase a combustion temperature. With this, the Ni-based super heat-resistant alloy which is a component material used for the above applications is required to have more excellent heat resistance, that is, high temperature strength properties that can maintain the strength at higher temperatures. In addition, in the precipitation-strengthening Ni-based super heat-resistant alloy, in order to improve the high temperature strength, it is most effective to increase the amount of “gamma prime (γ)” which is a precipitation strengthening phase of an intermetallic compound representatively denoted by Ni₃Al, Ni₃Ti, Ni₃; (TiAl), or the like. As the component material such as the aircraft engine and the power generation gas turbine, a Ni-based alloy having a large amount of the gamma prime precipitation tends to be used.

When the above component part is worn or damaged in a use process thereof, a defective part is repaired by a melting treatment such as build-up welding. At this time, as the melting material used for repair, a “wire for a melting treatment” which has the same component composition as that of the above-described component part, or has the similar component composition has been used (JP-A-2000-210789 and WO2006/132373).

Further, in a case of the Ni-based super heat-resistant alloy part having a complex shape such as a turbine blade, by using “3D printing” as a manufacturing method, there is an advantage in near net forming, short delivery time, high yield, and practical application has been progressing. In addition, even in this 3D printing, the supply of the above-described “wire for a melting treatment” is required.

### SUMMARY

In the near future, the amount of gamma prime precipitation in a precipitation-strengthening Ni-based super heat-resistant alloy tends to be further increased in order to obtain more excellent high temperature strength properties. However, as the ratio of the gamma prime in the structure of the precipitation-strengthening Ni-based super heat-resistant alloy is increased, the plastic workability of the precipitation-strengthening Ni-based super heat-resistant alloy are remarkably decreased. As a result, it is extremely difficult to process such a precipitation-strengthening Ni-based super heat-resistant alloy having a component composition with a high ratio of gamma prime into a wire shape.

An object of an exemplary embodiment of the present invention is to provide a wire for a melting treatment which has a component composition of a precipitation-strengthening Ni-based super heat-resistant alloy with a high ratio of gamma prime, and a method of producing the same.

According to an aspect of an exemplary embodiment of the present invention, there is provided a wire for a melting treatment which has, as a whole, a component composition of a precipitation-strengthening Ni-based super heat-resistant alloy in which an equilibrium precipitation amount of gamma prime at 700° C. is equal to or greater than 40% by mole. The wire has an integrated structure including: an element wire having a component composition in which the equilibrium precipitation amount of gamma prime at 700° C. is equal to or greater than 0% by mole and less than 40% by mole, and a material having a component composition in which the equilibrium precipitation amount of gamma prime at 700° C. is equal to or greater than 0% by mole and less than 40% by mole, and which is different from the component composition of the element wire.

In the wire, the material may be an element wire or a coated film.

In the wire, the component composition of the precipitation-strengthening Ni-based super heat-resistant alloy may contain Al of 2.0% to 8.0% by mass and Ti of 0.4% to 7.0% by mass.

According to another aspect of an exemplary embodiment of the present invention, there is provided a method of producing a wire for a melting treatment having a component composition of a precipitation-strengthen Ni-based super heat-resistant alloy. The method includes: performing plastic working of a first material having a component composition in which an equilibrium precipitation amount of gamma prime at 700° C. is equal to or greater than 0% by mole and less than 40% by mole, to obtain an element wire; and combining the obtained element wire with a second material having a component composition in which the equilibrium precipitation amount of gamma prime at 700° C. is equal to or greater than 0% by mole and less than 40% by mole, and which is different from the component composition of the first material, to obtain a wire having an integrated structure of the element wire and the material. The wire having the integrated structure has, as a whole, the component composition of the precipitation-strengthening Ni-based super heat-resistant alloy in which the equilibrium precipitation amount of gamma prime at 700° C. is equal to or greater than 40% by mole.

In the method, the material may be an element wire or a coated film.

In the method, the component composition of the precipitation-strengthening Ni-based super heat-resistant alloy may contain Al of 2.0% to 8.0% by mass and Ti of 0.4% to 7.0% by mass.

According to the present invention, it is possible to efficiently produce a wire for a melting treatment having a component composition of a precipitation-strengthening Ni-based super heat-resistant alloy which is difficult to perform plastic working in the related art.

### BRIEF DESCRIPTION OF THE DRAWINGS

FIGS. 1A to 1D are schematic diagrams showing exemplary embodiments of integrated structures in which materials, element wires, or a material and an element wire are combined.

### DETAILED DESCRIPTION

(1) A wire for a melting treatment according to an exemplary embodiment of the present invention has a component composition of a precipitation-strengthening Ni-based super heat-resistant alloy in which an equilibrium precipitation amount of gamma prime at 700° C. is equal to or greater than 40% by mole, as a whole.

The wire for a melting treatment according to an exemplary embodiment of the present invention is, as will be described below, “a wire in which a plurality of “materials (raw materials)” having different component compositions are combined”. Note that, in the wire for a melting treatment according to an exemplary embodiment of the present invention, the concept of the above-described material includes a shape of “element wire (raw wire)” described below. In addition, the component composition of the wire for a melting treatment “as a whole” in which the plurality of materials are combined with each other is a precipitation-strengthening Ni-based super heat-resistant alloy in which the equilibrium precipitation amount of gamma prime at 700° C. is equal to or greater than 40% by mole.

The wire for a melting treatment according to an exemplary embodiment of the present invention has an “individual component composition” which is independent for each of the plurality of materials in a state before the melting treatment. In addition, when the entire of the wire for a melting treatment is melted through the melting treatment, after the melting treatment, the “treated portion” formed by coagulating the entire of the melted wire becomes “single component composition” obtained by chemically combining the component compositions of the plurality of materials. In addition, from the aspect that the single component composition of the treated portion is a component composition of a constituent part, in the wire for a melting treatment according to an exemplary embodiment of the present invention, it is necessary for the component composition as a whole to have a high equilibrium precipitation amount of gamma prime in order for the above-described treated portion to have excellent high temperature strength properties.

In the Ni-based super heat-resistant alloy having a single component composition, the equilibrium precipitation amount of gamma prime varies depending on the temperature. Further, the equilibrium precipitation amount of gamma prime is increased from the minimum value as the temperature is decreased from the gamma prime precipitation initiation temperature (gamma prime solvus temperature), and generally, the temperature dependence becomes small (approximately constant value) at roughly equal to or less than 700° C. Accordingly, with respect to the equilibrium precipitation amount of gamma prime of the Ni-based super heat-resistant alloy, it is possible to understand the tendency of the entire precipitation amount of gamma prime (tendency of the high temperature strength properties) by setting the value at “700° C.” as a standard value (that is why the amount at 700° C. is frequently set as a standard value when it comes to the amount of gamma prime of a Ni-based super heat-resistant alloy, on industrial use). In an exemplary embodiment of the present invention, the wire for a melting treatment has, as a whole, a component composition of Ni-based super heat-resistant alloy in which the equilibrium precipitation amount of gamma prime at 700° C. is equal to or greater than. 40% by mole.

In the wire for a melting treatment according to an exemplary embodiment of the present invention, the above-described equilibrium precipitation amount of gamma prime at 700° C. is preferably equal to or greater than 50% by mole, and is more preferably equal to, or greater than 60% by mole. Note that, setting the upper limit of this value is not particularly necessary, but approximately 75% by mole is realistic as the upper limit.

The equilibrium precipitation amount of gamma prime of the precipitation-strengthening Ni-based super heat-resistant alloy means a stable precipitation amount of gamma prime in a thermodynamic equilibrium state. In addition, the value in which the equilibrium precipitation amount of gamma prime is represented by “% by mole” is a value that can be determined by the component composition of the precipitation-strengthening Ni-based super heat-resistant alloy. The value of “% by mole” of this equilibrium precipitation amount can be obtained by analysis through thermodynamic equilibrium calculation. In addition, in a case of the analysis through the thermodynamic equilibrium calculation, it is possible to easily calculate the amount with excellent accuracy by using various kinds of thermodynamic equilibrium calculation software.

As the component composition of the precipitation-strengthening Ni-based super heat-resistant alloy in which the equilibrium precipitation amount of gamma prime at 700° C. is “equal to or greater than 40% by mole”, for example, the component composition preferably contains Al of 2.0% to 8.0% by mass and Ti of 0.4% to 7.0% by mass (hereinafter, “% by mass” is simply denoted as %). Al and Ti in the precipitation-strengthening Ni-based super heat-resistant alloy are main elements forming the gamma prime, and are also elements forming an intermetallic compound with Ni to increase the proportion of the gamma prime phase in metallographic structure (that is, elements for increasing the heat resistance of treated portions after melting treatment).

<Al: 2.0% to 8.0%>

Al is an element for forming a gamma prime phase which is a precipitation-strengthening phase in a metallographic structure of a Ni-based super heat-resistant alloy, to improve high temperature strength of a treated portion after a melting treatment (hereinafter, simply referred to as a “treated portion”). However, when the content of Al is excessively large, the metallographic structure of the treated portion in the high temperature state becomes unstable. Thus, the content of Al is preferably in a range of 2.0% to 8.0%. The content of Al is more preferably equal to or greater than 3.0%, is even more preferably equal to or greater than 4.0%, and is particularly preferably equal to or greater than 5.5%. In addition, the content of Al is more preferably equal to or less than 7.5%, is even more preferably equal to or less than 7.0%, and particularly equal to or less than 6.5%.

<Ti: 0.4% to 7.0%>

Similar to Al, Ti is an element for forming a gamma prime phase in the metallographic structure to improve high temperature strength of the treated portion. However, when the content of Ti is excessively large, the metallographic structure of the treated portion in the high temperature state becomes unstable. Thus, the content of Ti is preferably in a range of 0.4% to 7.0%. The content of Ti is more preferably equal to or greater than 0.5%, and is even more preferably equal to or greater than 0.6%. In addition, the content of Ti is more preferably equal to or less than 6.0%, is even more preferably equal to or less than 5.0%, is even still more preferably equal to or less than 3.0%, and is particularly preferably equal to or less than 1.0%.

As one example of the component composition of the precipitation-strengthening Ni-based super heat-resistant alloy, a basic component composition of C of equal to or less than 0.250%; Cr of 8.0% to 22.0%; Mo of 2.0% to 7.0%; Al of 2.0% to 8.0%; Ti of 0.4% to 7.0%; and the balance of Ni and impurities may be exemplified.

<C: equal to or less than 0.250%>

C has an effect of improving the strength of the grain boundary in the metallographic structure of the treated portion. However, when the content of C is excessively large, a coarse carbide is formed in the metallographic structure of the treated portion, and thereby the strength is deteriorated. Accordingly, the content of C is preferably equal to or less than 0.250%. The content of C is more preferably equal to or less than 0.150%, is even more preferably equal to or less than 0.110%, is even still more preferably equal to or less than 0.050%, and is particularly preferably equal to or less than 0.020%. In addition, in a case where the above-described effect is obtained by containing C, the content of C is preferably equal to or greater than 0.001%, is more preferably equal to or greater than 0.003%, is even more preferably equal to or greater than 0.005%, and is particularly preferably 0.010%.

On the other hand, in a case where C may be set as an additive-free level (impurity level of raw material), the lower limit of C can be set to be 0%.

<Cr: 8.0% to 22.0%>

Cr is an element for improving oxidation resistance and corrosion resistance of the treated portion. However, when the content of Cr is excessively large, a large number of embrittled phases such as a sigma (σ) phase are formed in the metallographic structure of the treated portion, and thereby the strength of the treated portion is deteriorated. Accordingly, the content of Cr is preferably in a range of 8.0% to 22.0%. The content of Cr is more preferably equal to or greater than 9.0%, is even more preferably equal to or greater than 9.5%, and is particularly preferably equal to or greater than 10.0%. In addition, the content of Cr is more preferably equal to or less than 18.0%, is even more preferably equal to or less than 16.0%, is even still more preferably equal to or less than 14.0%, and is particularly preferably equal to or less than 13.0%.

<Mo: 2.0% to 7.0%22

Mo is an element that contributes to solid solution strengthening in a matrix of the metallographic structure to improve the high temperature strength of the treated portion. However, when the content of Mo is excessively large, a brittle intermetallic compound phase such as a Laves phase is formed, and thereby the high temperature strength of the treated portion is deteriorated. Accordingly, the content of Mo is preferably in a range of 2.0% to 7.0%. The content of Mo is more preferably equal to or greater than 2.5%, is even more preferably equal to or greater than 3.0%, and is particularly preferably equal to or greater than 3.5%. In addition, the content of Mo is more preferably equal to or less than 6.0%, is even more preferably equal to or less than 5.0%, and is particularly preferably equal to or less than 4.0%.

In the above-described basic component composition, if necessary, one or two or more additional elements selected from the consisting of: Co of equal to or less than 28.0%; W of equal to or less than 6.0%; Nb of equal to or less than 4.0%; Ta of equal to or less than 3.0%; Fe of equal to or less than 10.0%; V of equal to or less than 1.2%; Hf of equal to or less than 1,0%; B of equal to or less than 0.300%; and Zr of equal to or less than 0.30% may be contained.

<Co: equal to or less than 28.0%>

Co improves the toughness of the metallographic structure of the treated portion and the stability at high temperature. However, when Co is expensive and when the content thereof is excessively large, a Co-base brittle intermetallic compound is generated, Accordingly, if necessary, the content of Co is preferably equal to or less than 28.0%, is more preferably equal to or less than 18.0%, is even more preferably equal to or less than 16.0%, and is particularly preferably equal to or less than 13.0%. In addition, in a case where the above-described effect is obtained by containing Co, the content of Co is preferably equal to or greater than 1.0%, is more preferably equal to or greater than 3.0%, is even more preferably equal to or greater than 8.0%, and is particularly preferably equal to or greater than 10.0%.

On the other hand, in a case where Co may be set as an additive-free level (impurity level of raw material), the lower limit of Co can be set to be 0%. Further, the content of Co can be less than 1.0%.

<W: equal to or less than 6.0%>

Similar to Mo, W is a selective element contributing to the solid solution strengthening of the matrix. Further, when added in combination with Mo, a higher solid solution strengthening effect can be exhibited. However, when the content of W is excessively large, a brittle intermetallic compound phase such as a Laves phase is formed, and thereby the high temperature strength of the treated portion is deteriorated. Thus, if necessary, W is preferably equal to or less than 6.0%, is more preferably equal to or less than 5.5%, is even more preferably equal to or less than 5.0%, and is particularly preferably equal to or less than 4.5%. In addition, in a case where the above-described effect can be obtained by containing W, the content of W is preferably equal to or greater than 0.8%, and is more preferably equal to or greater than 1.0%.

On the other hand, in a case where W may be set as an additive-free level (impurity level of raw material), the lower limit of W can be set to be 0%. In addition, the content of W can be less than 1.0%, and further can be less than 0.8%.

<Nb: equal to or less than 4.0%>

Similar to Al and Ti, Nb is a selective element that forms the gamma prime phase to improve the high temperature strength of the treated portion. However, when the content of Nb is excessively large, a delta (δ) phase is formed in the metallographic structure of the treated portion, and thereby the effect of improving the high temperature strength by Ti is inhibited. Accordingly, if necessary, Nb is preferably equal to or less than 4.0%, is more preferably equal to or less than 3.5%, is even more preferably equal to or less than 3.0%, and is particularly preferably equal to or less than 2.5%. In addition, in a case Where the above-described effect is obtained by containing Nb, the content of Nb is preferably equal to or greater than 0.5%, is more preferably equal to or greater than 1.0%, is even more preferably equal to or greater than 1.5%, and is particularly preferably equal to or greater than 2.0%.

On the other hand, in a case where Nb may be set as an additive-free level (impurity level of raw material), the lower limit of Nb can be set to be 0%. In addition, the content of Nb can be less than 0.5%.

<Ta: equal to or less than 3.0%>

Similar to Al and Ti, Ta is a selective element that forms the gamma prime Phase to improve the high temperature strength of the treated portion. However, when the content of Ta is excessively large, the gamma prime phase is unstable at high temperature, and thereby it is difficult to obtain the effect of improving the high temperature strength. Accordingly, if necessary, Ta is preferably equal to or less than 3.0%, is more preferably equal to or less than 2.5%, is even more preferably equal to or less than 2.0%, and is particularly preferably equal to or less than 1.5%. In addition, in a case where the above-described effect is obtained by containing Ta, the content of Ta is preferably equal to or greater than 0.3%, is more preferably equal to or greater than 0.5%, is even more preferably equal to or greater than 0.7%, and is particularly preferably equal to or greater than 1.0%.

On the other hand, in a case where Ta may be set as an additive-fine level (impurity level of raw material), the lower limit of Ta can be set to be 0%. In addition, the content of Ta can be less than 0.3%.

<Fe: equal to or less than 10.0%>

Fe is a selective element that can be used instead of expensive Ni or Co, and is effective for reducing the alloy cost. However, when the content of Fe is excessively large, an embrittled phase such as a Laves phase in the structure is formed, and thereby the strength is deteriorated. Accordingly, if necessary, the content of Fe is preferably equal to or less than 10.0%, is more preferably equal to or less than 9.0%, is even more preferably equal to or less than 8.0%, is even still more preferably equal to or less than 6.0%, and is particularly preferably equal to or less than 3.0%. In addition, in a case where the above-described effect is obtained by containing Fe, the content of Fe used instead of the content of Ni or Co, is, for example, preferably equal to or greater than 0.1%, is more preferably equal to or greater than 0.4%, is even more preferably equal to or greater than 0.6%, and is particularly preferably equal to or greater than 0.8%.

On the other hand, in a case where Fe may be set as an additive-free level (impurity level of raw material), the lower limit of Fe can be set to be 0%. In addition, the content of Fe can be less than 0.1%.

<V: equal to or less than 1.2%>

V is a selective element that is useful for solid solution strengthening of the matrix, and grain boundary reinforcement by generation of carbide. However, when the content of V is excessively large, an intermetallic compound is formed in the metallographic structure of the treated portion, and thereby the high temperature strength is deteriorated. Accordingly, if necessary, the content of V is preferably equal to or less than 1.2%, is more preferably equal to or less than 1.0%, is even more preferably equal to or less than 0.8%, and is particularly preferably equal to or less than 0.7%. In addition, in a case where the above-described effect is obtained by containing V, the content of V is preferably equal to or greater than 0.1%, is more preferably equal to or greater than 0.2%, is even more preferably equal to or greater than 0.3%, and is particularly preferably equal to or greater than 0.5%.

On the other hand, in a case where V may be set as an additive-free level (impurity level of raw material), the lower limit of V can be set to be 0%. In addition, the content of V can be less than 0.1%.

<Hf: equal to or less than 1.0%>

Hf is a selective element that is useful for the improvement of the oxidation resistance of the treated portion, and grain boundary reinforcement by generation of carbide. However, when the content of Hf is excessively large, carbide is generated in the metallographic structure of the treated portion, and thereby the mechanical properties of the alloy are damaged. Accordingly, if necessary, the content of Hf is preferably equal to or less than 1.0%, is more preferably equal to or less than 0.8%, is even more preferably equal to or less than 0.7%, even still more preferably equal to or less than 0.5%, and is particularly preferably equal to or less than 0.3%. In addition, in a case where the above-described effect is obtained by containing Hf, the content of Hf is preferably equal to or greater than 0.02%, is more preferably equal to or greater than 0.05%, is even more preferably equal to or greater than 0.1%, and is particularly preferably equal to or greater than 0.15%.

On the other hand, in a case where Hf may be set as an additive-free level (impurity level of raw material), the lower limit of Hf can be set to be 0%. In addition, the content of Hf can be less than 0.02%.

<B: equal to or less than 0.300%>

B is an element of enhancing the grain, boundary strength of the metallographic structure to improve creep strength and ductility of the treated portion. However, when the content of B is excessively large, the melting point of the treated portion is slightly decreased, and thereby the high temperature strength is adversely affected. Accordingly, if necessary, the content of B is preferably equal to or less than 0.300%, is more preferably equal to or less than 0.200%, is even more preferably equal to or less than 0.100%, is even still more preferably equal to or less than 0.080%, and is particularly preferably equal to or less than 0.020%. In addition, in a case where the above-described effect is obtained by containing B, the content of B is preferably equal to or greater than 0.001%, is more preferably equal to or greater than 0.003%, is even more preferably equal to or greater than 0.005%, and is particularly preferably equal to or greater than 0.007%.

On the other hand, in a case where B may be set as an additive-free level (impurity level of raw material), the lower limit of B can be set to be 0%. In addition, the content of B can be less than 0.001%.

<Zr: equal to or less than 0.30%>

Similar to B, Zr is an element for improving the grain boundary strength of the metallographic structure of the treated portion. However, when Zr is excessively large, the melting of the treated portion is slightly decreased, and thereby the high temperature strength is adversely affected. Accordingly, if necessary, Zr is preferably equal to or less than 0.30%, is more preferably equal to or less than 0.25%, is even more preferably equal to or less than 0.20%, and is particularly preferably equal to or less than 0.15%. In addition, in a case where the above-described effect is obtained by containing Zr, the content of Zr is preferably equal to or greater than 0.001%, is more preferably equal to or greater than 0.005%, is even more preferably equal to or greater than 0.01%, and is particularly preferably equal to or greater than 0.03%.

On the other hand, in a case where Zr may be set as an additive-free level (impurity level of raw material), the lower limit of Zr can be set 0%. In addition, the content of Zr can be less than 0.001%.

(2) The wire for a melting treatment according to an exemplary embodiment of the present invention has an integrated structure in which an element wire having a component composition in which the equilibrium precipitation amount of gamma prime at 700° C. is equal to or greater than 0% by mole and less than 40% by mole is combined with a material having a component composition in which the equilibrium precipitation amount of gamma prime at 700° C. is equal to or greater than 0% by mole and less than 40% by mole and which is different from that: of the wire.

In an exemplary embodiment of the present invention, from the aspect that after the melting treatment, the treated portion has the component composition of the precipitation-strengthening Ni-based. super heat-resistant alloy in which the “equilibrium precipitation amount of gamma prime at 700° C. is equal to or greater than 40% by mole”, the wire for a melting treatment exhibits excellent heat resistance as a “product” after the melting treatment. On the other hand, the alloy having the component composition in which the “equilibrium precipitation amount of gamma prime at 700° C. is equal to or greater than 40% by mole” is lack of the plastic workability, and thus is difficult to be processed in a wire shape.

That is, hot plastic working of the precipitation-strengthening Ni-based super heat-resistant alloy is, typically, performed in a “temperature range” from a solid solution temperature (gamma prime solves temperature) at which the gamma prime is dissolved to a solidus temperature of the precipitation-strengthening Ni-based super heat-resistant alloy. At this time, the precipitation-strengthening Ni-based super heat-resistant alloy having the component composition with the high ratio of the gamma prime has the high gamma prime solvus temperature but the low solidus temperature. Therefore, the temperature range where the plastic working is possible is narrow. In addition, particularly, in the case of the precipitation-strengthening Ni-based super heat-resistant alloy in which the equilibrium precipitation amount of gamma prime at 700° C. is equal to or greater than 40%, the above-mentioned temperature range where the plastic working is possible is almost eliminated, and in fact, it is difficult to perform the plastic working.

In the related art, the wire for a melting treatment having a component composition that is considered to be difficult to perform plastic working is produced by, for example, “directly” casting a molten metal having the same component composition into a wire having a diameter of several millimeters, and if necessary, performing the mild plastic working on this wire material (JP-A-2000-210789). In the case of a wire made by such a direct casting method, a special mold, a cooling device, and the like are required for its production. In addition, from the aspect that casting defects in the wire are likely to remain and are brittle, in a case of the precipitation-strengthening Ni-based super heat-resistant alloy in which the equilibrium precipitation amount of gamma prime at 700° C. is equal to or greater than 40%, for example, it is difficult to make a thin wire of equal to or less than 3 mm. Further, since it is difficult to secure the length that can be used as a winding wire (coil), it is impossible to continuously supply the wire at the time of the melting treatment (the wire needs to be frequently exchanged), and the productivity related to the melting treatment is low.

In this regard, in an exemplary embodiment of the present invention, a method of efficiently obtaining a wire for a melting treatment in which the “equilibrium precipitation amount of gamma prime at 700° C. is equal to or greater than 40% by mole” is studied. As a result, when considering that in any case after the melting treatment, the wire for a melting treatment becomes a “single component composition” in which the component compositions before the melting treatment are chemically combined, there is no need to be the chemically combined single component composition at the time of the “wire” before the melting treatment. In addition, at the time of the wire before the melting treatment, as long as the wire has, as a whole, the component composition of the precipitation-strengthening Ni-based super heat-resistant alloy in which the “equilibrium precipitation amount of gamma prime at 700° C. is equal to or greater than 40% by mole”, the plurality of materials in which the component compositions are different from each other may be “integrally” combined.

Accordingly, in a case where the component composition “as a whole” of the target wire for a melting treatment is divided into a plurality of component compositions each of which is easy to perform plastic working (that is, the equilibrium precipitation amount of gamma prime at 700° C. is small), and a plurality of materials having the component compositions are combined among one another so as to form a wire having the integrated structure, it is possible to produce the wire for a melting treatment having a target component composition. In addition, among the above-described plurality of materials, if one or more of the materials, or all of the materials are set as an “element wire” obtained by plastic working, and the element wire and the remaining materials are integrally combined so as to be along the longitudinal direction of the element wire, it is possible to efficiently produce a wire for a melting treatment having a component composition of a precipitation-strengthening Ni-based super heat-resistant. alloy which would be inherently difficult to have the integrated structure.

In addition, in a case where the component composition as a whole is divided into a plurality of component compositions, allocation of divided component compositions should be important in an exemplary embodiment of the present invention. That is, the component composition of each material should be determined. If the component composition of the material has the “equilibrium precipitation amount of gamma prime at 700° C. which is equal to or greater than 40% by mole”, when a portion of the material is supplied in a shape of the “element wire”, it is difficult to produce even the element wire by plastic working. In this case, it is unchanged from the case without division, and thus it is not possible to efficiently produce the wire for a melting treatment having the component composition of the precipitation-strengthening Ni-based super heat-resistant alloy. Accordingly, each of the plurality of materials according to an exemplary embodiment of the present invention, including the materials provided in the shape of the element wire, has a component composition in which the equilibrium precipitation amount of gamma prime at 700° C. is equal to or greater than 0% and less than 40% by mole. Regarding one or two or more among the above-described materials, the value of the equilibrium precipitation amount is preferably equal to or less than 20% by mole, is more preferably equal to or less than 10% by mole, and is even more preferably equal to or less than 5% by mole. The preferable value of the equilibrium precipitation amount effectively acts in a case where the material is in the shape of the “element wire” particularly.

When the equilibrium precipitation amount of gamma prime of each of the materials at 700° C. is equal to or greater than 0% by mole and less than 40% by mole, it is possible to sufficiently secure the plastic workability of the materials, and thus it is efficient when a portion or the entire of each of the materials is provided as the “element wire”. As the amounts of gamma prime of the materials are decreased from “40% by mole”, the plastic workability of the materials are improved. Note that, regarding the above-described “0% by mole”, it includes a case where the concept that “gamma prime” such as metals of Al and Ti, which will be described below, or alloys of these metals is formed does not exist in the first place.

In a case where the component composition as a whole is divided into the plurality of component compositions, the method of allocating the divided component compositions is not particularly limited. For example, in principle, it is also possible to set the component composition for each of the above materials as a “single metal” corresponding to the element kind constituting the component composition of the target wire for a melting treatment. Here, reducing the “kinds of materials” separated by each component composition makes it easier to combine these materials with “one wire for a melting treatment”. In addition, it is easy to make the component compositions of the treated portion after melting treatment uniform. Accordingly, the number of the material kinds is preferably equal to or less than seven, is more preferably equal to or less than four, is even more preferably equal to or less than three, and is most preferably two.

In addition, as one example of the method of dividing the component composition, for example, if each of the divided component compositions has the equilibrium precipitation amount of gamma prime at 700° C. Which is equal to or greater than 0% and less than 40% by mole, a method of dividing each of the component compositions into a “base component” consisting of Ni and a “complementary component” consisting of any one or combination of additive elements such as Cr, Mo, Al, Ti, and the like can be exemplified. At this time, for the above base component, it may be one containing some additive elements (for example, an alloyed material). Regarding this, when the plurality of materials each of which has a component composition are combined so as to form one wire for a melting treatment, the component composition as a whole may be adjusted so as to match with the target component composition in accordance with the shape and number of the material (in the case of a wire, a wire diameter, the number of the wires, and the like).

In addition, examples of preferred methods of allocating the divided component compositions include a method in which a “gamma prime forming element” which exclusively forms the gamma prime is subtracted from the component composition as a whole so as to form a “base component” which suppress the forming of the gamma prime, the component composition which can complement the content of the subtracted gamma prime forming element is set as a “complementary component”, and a material having the base component and a material having the complementary component are combined with each other.

To describe a specific example, first, the reason why the component composition as a whole (that is, the component composition of the precipitation-strengthening Ni-based super heat-resistant alloy in which the equilibrium precipitation amount of gamma prime at 700° C. is equal to or greater than 40% by mole) easily forms the gamma prime in the structure is that the component composition contains a large amount of the “gamma prime forming elements” such as Al and Ti. Thus, the allocation of the divided component compositions is reasonably and efficiently performed by setting as a “base component” the component composition obtained by subtracting Al or Ti from the component composition as a whole, and the component composition as a “complementary component” which compliments the content of the subtracted Al or Ti. In this case, for the base component, it is preferable that Al is adjusted to be “equal to or greater than 0% and less than 2.0%”, Ti is adjusted to be “equal to or greater than 0% and less than 0.8%” in the component composition as a whole (in other words, an Ni-based alloy having the content of Al or Ti). It is more preferable that Al is adjusted to be “equal to or greater than 0% and less than 2.0%”, and Ti is adjusted to be “equal to or greater than 0% and less than 0.8%”. Al is more preferably equal to or less than 1.0%, and is even more preferably equal to or less than 0.8%. Ti is more preferably equal to or less than 0.7%, and is even more preferably equal to or less than 0.5%. In addition, as the complementary component, a component composition such as Al or an Al alloy, Ti and a Ti alloy, or a TiAl alloy is preferably used.

In addition, in an exemplary embodiment of the present invention in which one or more of the materials as an “element wire”, it is preferable to provide the material having the base component as an “element wire”. Generally, the element wire is efficiently produced by plastic working with a material such as a billet (stock material) as a starting material. Further, in the case of the element wire having the above base component, a material such as a billet having the same component composition is excellent in plastic workability, and thus the element wire can be easily produced by plastic working this material in the first step in the manufacturing method of the wire for a melting treatment in an exemplary embodiment of the present invention. In addition, in this case, the wire diameter of the element wire can be, for example, equal to or greater than 0.1 mm and less than 5.0 mm. Further, the wire diameter can be less than 3.0 mm, and thereby it is possible to obtain an element wire which is less than 1.0 mm.

Meanwhile, the material having the complementary component is not necessarily provided as an “element wire” so far. In other words, in the method of producing the wire for a melting treatment according to an exemplary embodiment of the present invention, for example, it is considered that in the second step of obtaining the wire having the integrated structure by combining the materials, the element wire having the base component is prepared as a “core wire” of the wire for a melting treatment, and the material having the complementary component on the surface of the core wire is set as a coated film obtained through various coating processes such as plating and vapor deposition. In addition, in this case, providing one or more of the materials as an “element wire” has an advantage in reducing man-hours required to integrate materials into an integrated structure in the second step, from the aspect that the element wire can be functioned as the above-described core wire. Further, the above material which complements the component composition can be formed “uniformly (to be even thickness)” on the surface of the core wire, and thus it is easy to make the component composition as a whole of the Wire for a melting treatment uniform.

In addition, similar to the material having the base component, a material having a complementary component can be also provided in a shape of an “element wire”. That is, even with the material having the above-described complementary component, a material such as a billet having the same component composition is excellent in plastic workability, and thus it is possible to easily produce the element wire having the complementary component by plastic working the material. In addition, in this case, the wire diameter of the element wire can be set equal to or greater than 0.1 mm and less than 5.0 mm. Further, it is also possible to obtain an element wire having the wire diameter of less than 3.0 mm, and less than 1.0 mm. In the second step, it can be considered that an element wire having the base component and an element wire having the complementary component are combined so as to obtain an integrated wire. In other words, the aforementioned wire is the wire for a melting treatment having an integrated structure in which a plurality of element wires having different component compositions are combined, and each of the plurality of element wires is the wire for a melting treatment having the component composition in which the equilibrium precipitation amount of gamma prime at 700° C. is equal to or greater than 0% by mole and less than 40% by mole.

In this case, providing all the materials as an “element wire” has an advantage in reducing man-hours required to integrate materials into an integrated structure in the second step, from the aspect that the handling ability as the material are improved. Also, each element wire has a fixed component composition, and thus it is easy to adjust the component composition as a whole of the wire for a melting treatment in the second step as described above.

Regarding the element wire with the complementary component, the element wire of Al or Ti is obtained by self-production or is easily obtained as a commercially available product, for example. In addition, as the commercially available products, various wire diameters (shapes) are prepared. Accordingly, in a case where the commercially available product is used as an element wire, the wire diameter (shape) and the number of the commercially available wires are selected so as to match with the target component composition as a whole, and thereby it is possible to further reduce the number of man-hours and costs involved in the production of the wire for a melting treatment, and to further improve the production efficiency.

The number of the “plurality of” materials in an exemplary embodiment of the present invention is not limited by the existence of the different component compositions. In other words, in a case where the component composition as a whole is divided, for example, into “two” component compositions, the number of the materials is at least “two”. At this time, if the materials are “element wires”, the number of the element wires is at least “two”. In addition, in a case where the materials having the same component compositions as those of either one or both materials are added to these two materials, the number of the materials is three or four or more.

The “element wire” in an exemplary embodiment of the present invention is not limited as long as the shape is long in the length direction of the “wire for a melting treatment” after being combined. For example, it is conceivable that it is a hoop shape, a ribbon shape, or the like in addition to the linear shape.

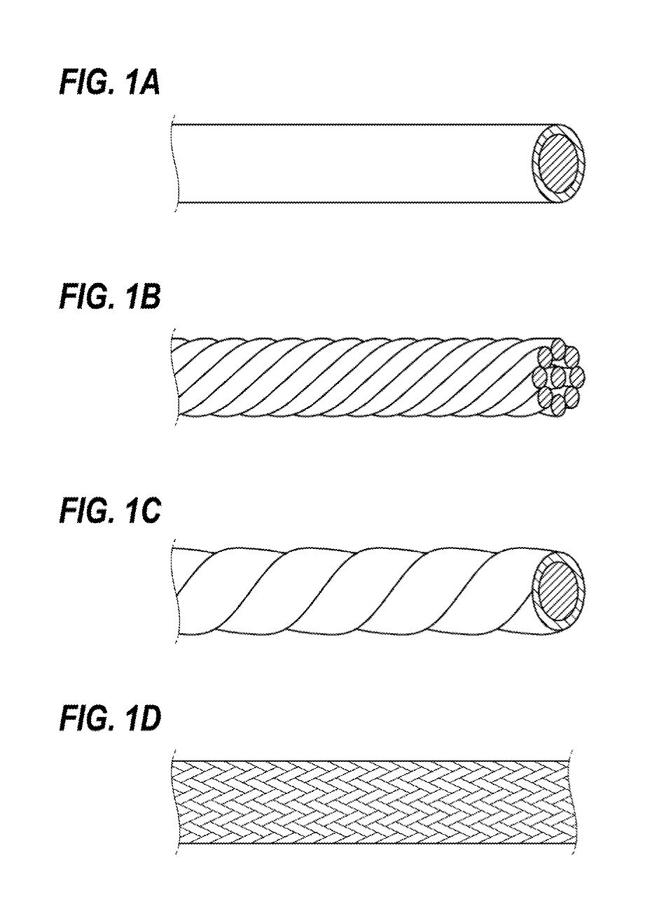

The “materials, element wires, or a material and an element wire are combined” in an exemplary embodiment of the present invention means that a “structure in which the materials are physically bound to each other”, that is, a “structure in which the component compositions of the materials are chemically independent from each other”. For example, as shown in FIG. 1A, it is a structure in which the surface of the element wire is coated with a material in the form of a plating layer, a vapor deposition layer, or the like. Alternatively, as shown in FIG. 1B, it is a structure in which the element wires are twisted (twined) in the longitudinal direction. Or, as shown in FIG. 1C, it is a structure in which the periphery of the element wire is covered by being wrapped with a hoop, a ribbon, or the like. In addition, as shown in FIG. 1D, it is also conceivable that the hoop and the ribbon are linearly made, for example, by intertwining them in the length direction thereof. Further, in this combining step (that is, the above-described second step), each of the materials or element wires is excellent in plastic workability (bending workability), and thus it is easy to form the structures as described above.

The number or the shape of the materials (or the element wires), and the structure in which the materials are combined with each other may be selected so as to match with the target component composition as a whole when the plurality of materials are combined to form one wire for a melting treatment.

According to an exemplary embodiment of the present invention, for example, it is possible to provide a thin wire for a melting treatment of Which the wire diameter is in a range of 0.2 to 5.0 mm. Further, it is possible to provide a very thin wire for a melting treatment of which the wire diameter is equal to or less than 3.0 mm, and less than 1.0 mm. Note that, at this time, if the wire for a melting treatment is a structure difficult to define the wire diameter of a structure of a twisted wire or the like, a cross-sectional area of the wire for a melting treatment may be obtained and a diameter of a circle having the cross-sectional area may be set as the wire diameter.

### EXAMPLE 1

A wire for a melting treatment in which a component composition as a whole satisfies a standard value of “713C alloy (Table 1)” was produced. Note that, the equilibrium precipitation amount of gamma prime at 700° C. of the 713C alloy was obtained by using thermodynamic equilibrium calculation software “JMatPro (Version 8.0.1, developed by Sente Software Ltd.)”. As a result of the calculation by inputting the content of each element listed in Table 1 in the thermodynamic equilibrium calculation software, the lower limit was 68% by mole, and the upper limit was 70% by mole in a range of the component composition in Table 1.

TABLE 1
(mass %)

| | | C | Cr | Mo | Al | Ti | Nb | Fe | Ni* |
|---|---|---|---|---|---|---|---|---|---|
| 713C | Upper limit | 0.02 | 12.5 | 4.7 | 6.1 | 0.7 | 2.1 | 1.1 | Balance |
| alloy | Lower limit | 0.001 | 11.5 | 4.3 | 5.7 | 0.5 | 1.9 | 0.9 | |

*Including impurities

First, as a “base component” in a case where the component composition in Table 1 was divided, an alloy A having a component composition in Table 2 was prepared. The alloy A is an Ni-based alloy obtained by removing an “Al component” from the component composition in Table 1 (Co, W, Ta, V, Hf, B, and Zr were impurity elements, and thus Co≦28.0%, W≦6.0%, Ta≦3.0%, V≦1.2%, Hf≦1.0%, B≦0.300%, and Zr≦0.30% were satisfied). In addition, as a result of calculating the equilibrium precipitation amount of gamma prime at 700° C. of the alloy A by using the same thermodynamic equilibrium calculation software (JMatPro) as described above, the equilibrium precipitation amount was “0”% by mole. Further, it was possible to produce an element wire A having a wire diameter of 0.50 mm by performing plastic working such as forging, rolling, and cold drawing on a billet which has a diameter of 100 mm and is formed of the alloy A (first step).

TABLE 2
(mass %)

| | C | Cr | Mo | Al | Ti | Nb | Fe | Ni* |
|---|---|---|---|---|---|---|---|---|
| Alloy A | 0.016 | 12.8 | 4.8 | — | 0.64 | 2.1 | 1.1 | Balance |

*Including impurities

On the other hand, as a “complementary component” in a case where the component composition in Table 1 was divided, a metal B having a component composition of Al was prepared. Al is a metal excellent in plastic workability, which has no concept that “gamma prime is formed”. In this example, a commercially available Al wire having a wire diameter of 0.28 mm was prepared and was designated as an element wire B.

Then, when twisting the element: wire A and the element wire B above, the combination conditions of the element wire A and the element wire B were selected such that the component composition as a whole of the twisted wire satisfies the standard value of “713C alloy (Table 1)” on the calculation. In addition, as a result of using the selected conditions, in the combination of five element wires A and three element wires B, the element wires A and the element wires B were twisted with each other, and thereby it was possible to produce the wire for a melting treatment having an integrated structure according to an exemplary embodiment of the present invention (second step). The length of the wire for a melting treatment was 1 m, and the wire diameter was 1.22 mm.

A sample of 5 mm in length was taken from the wire for a melting treatment, the sample was subjected to a melting treatment to prepare a coagulated substance (treated portion), and then the component composition of the coagulated substance was analyzed. The result is indicated in Table 3. The component composition in Table 3 satisfied the standard value of the 713C alloy indicated in Table 1 (Co, W, Ta, V, Hf, B, and Zr were impurity elements, and thus Co≦28.0%, W≦6.0%, Ta≦3.0%, V≦1.2%, Hf≦1.0%, B≦0.300%, and Zr≦0.30% were satisfied).

TABLE 3
(mass %)

| | C | Cr | Mo | Al | Ti | Nb | Fe | Ni* |
|---|---|---|---|---|---|---|---|---|
| Coagulated substance | 0.013 | 11.9 | 4.5 | 5.9 | 0.6 | 2.0 | 1.0 | Balance |

*Including impurities

### Example 2

Similar to Example 1, a wire for a melting treatment in which a component composition as a whole satisfies a standard value of “713C alloy (Table 1)” was produced.

First, as a “base component” in a case where the component composition in Table 1 was divided, an alloy A having a component composition in Table 2 was prepared. Then, an element wire C having a wire diameter of 1.10 mm was produced by using the alloy A (first step). In addition, when plating coating a material formed of Al on the surface of the element wire C, the conditions of a plating layer were selected so as to make the component composition as a whole of the wire after plating and coating, satisfy the standard value of “713C alloy (Table 1)” on the calculation. As a result of using the selected conditions, a coated film formed of an Al plating layer having the thickness of approximately 0.1 mm was formed on the surface of the element wire C, and thereby it was possible to produce the wire for a melting treatment of the present invention (second. step). At this time, the plating treatment was performed by using an electroless plating. method. The length of the wire for a melting treatment after the plating and coating was 1 m, and the wire diameter was approximately 1.3 mm.

A sample of 5 mm in length was taken from the wire for a melting treatment, and the sample was subjected to a melting treatment to prepare a coagulated substance (treated portion). Then the component composition of the coagulated substance satisfied the standard value of the 713C alloy indicated in Table 1 (Co, W, Ta, Hf, B, and Zr were impurity elements, and thus Co≦28.0%, W≦6.0%, Ta≦3.0%, V≦1.2%, Hf≦1.0%, B≦0.300%, and Zr≦0.30% were satisfied).

1. A wire for a melting treatment which has, as a whole, a component composition of a precipitation-strengthening Ni-based super heat-resistant alloy in which an equilibrium precipitation amount of gamma prime at 700° C. is equal to or greater than 40% by mole,
the wire comprising an integrated structure including:
an element wire having a component composition in which the equilibrium precipitation amount of gamma prime at 700° C. is equal to or greater than 0% by mole and less than 40% by mole; and
a material having a component composition in which the equilibrium precipitation amount of gamma prime at 700° C. is equal to or greater than 0% by mole and less than 40% by mole, and which is different from the component composition of the element wire.

2. The wire for a melting treatment according to claim 1,
wherein the material is an element wire or a coated film.

3. The wire for a melting treatment according to claim 1,
wherein the component composition of the precipitation-strengthening Ni-based super heat-resistant alloy contains Al of 2.0% to 8.0% by mass and Ti of 0.4% to 7.0% by mass.

4. A method of producing a wire for a melting treatment having a component composition of a precipitation-strengthening Ni-based super heat-resistant alloy, the method comprising:
performing plastic working of a first material having a component composition in which an equilibrium precipitation amount of gamma prime at 700° C. is equal to or greater than 0% by mole and less than 40% by mole, to obtain an element wire; and
combining the obtained element wire with a second material having a component composition in which the equilibrium precipitation amount of gamma prime at 700° C. is equal to or greater than 0% by mole and less than 40% by mole, and which is different from the component composition of the first material, to obtain a wire having an integrated structure of the element wire and the material,
wherein the wire having the integrated structure has, as a whole, the component composition of the precipitation-strengthening Ni-based super heat-resistant alloy in which the equilibrium precipitation amount of gamma prime at 700° C. is equal to or greater than 40% by mole.

5. The method of producing a wire for a melting treatment according to claim 4,
wherein the second material is an element wire or a coated film.

6. The method of producing a wire for a melting treatment according to claim 4,
wherein the component composition of the precipitation-strengthening Ni-based super heat-resistant alloy contains Al of 2.0% to 8.0% by mass and Ti of 0.4% to 7.0% by mass.

7. The method of producing a wire for a melting treatment according to claim 5,
wherein the component composition of the precipitation-strengthening Ni-based super heat-resistant alloy contains Al of 2.0% to 8.0% by mass and Ti of 0.4% to 7.0% by mass.
